(19) United States
(12) Patent Application Publication
(10) Pub. No.: US 2017/0366510 A1
(43) Pub. Date: Dec. 21, 2017

(54) COGNITIVE CONFIDENTIALITY GUARDIAN

(71) Applicant: International Business Machines Corporation, Armonk, NY (US)

(72) Inventors: Ermyas Abebe, Altona (AU); Mahathir B.A. Almashor, Airport West (AU); Adam H. E. Eberbach, Surrey Hills (AU); Hidemasa Muta, Hachioji-shi (JP); Jorge A. Moros Ortiz, Carlton (AU)

(21) Appl. No.: 15/186,647

(22) Filed: Jun. 20, 2016

(51) Int. Cl. H04L 29/06; G06N 99/00; H04L 12/58; G06N 7/00

(52) U.S. Cl. CPC H04L 63/04; H04L 63/20; G06N 7/005; G06N 99/005; H04L 51/046

(57) ABSTRACT

Protecting secure information in computer communications may include detecting by a computer process running on a server an initiation of an action if executed transmits data to a destination domain. Whether the destination domain is a permissible destination for sending the secure information may be determined. If it is determined that the destination domain is not a permissible destination, whether the data contains secure information may be determined. Responsive to determining that the data contains secure information, an alert signal may be generated to alert an initiator of the action. Responsive to determining that the action is executed even after the alert signal, the computer process may be trained to learn that the destination domain is permissible destination.

### FIELD

The present application relates generally to computers and computer applications, and more particularly to computer network security and machine learning.

### BACKGROUND

In an environment where sensitive or secret information must be handled on systems, for example, where public internet access is also necessary, there is a risk of information becoming public when it should not. Examples may include users of a system inadvertently emailing sensitive information to unauthorized contacts, for example, in response to earlier group mailings and on long, hard-to-track messaging threads. There is also the common occurrence of mistaken identity, such as sending sensitive data to a recipient with the same name as the intended recipient, for instance, at a different location or address. This may occur, for example, where multiple instances of a name appear in a contacts database. A contact database that lists a recipient with both secure and non-secure addresses may also pose a problem. Security issues affect all forms of online communications, for example, emails, instant messaging platforms, and even social media.

### BRIEF SUMMARY

A method and system of training a machine to protect secure information in computer communications may be provided. The method, in one aspect, may include detecting by a computer process running on a server an initiation of an action if executed transmits data to a destination domain. The method may also include determining whether the destination domain is a permissible destination for sending the secure information data contains secure information. The method may further include, responsive to determining that the destination domain is not the permissible destination, determining whether the data contains secure information. The method may also include, responsive to determining that the data contains secure information, generating an alert signal to alert an initiator of the action. The method may also include determining whether the action is executed subsequent to alerting the initiator of the action. The method may further include, responsive to determining that the action is executed, training the computer process to learn that the destination domain is permissible destination.

A system of training a machine to protect secure information in computer communications, in one aspect, may include at least one hardware processor coupled to a communication interface. The hardware processor may run a computer operating system level process operable to detect an initiation of an action if executed transmits data to a destination domain via the communication interface. The hardware processor may run a cognitive process operable to determine whether the destination domain is permissible destination for sending secure information. Responsive to determining that the destination domain is not a permissible destination, the cognitive process may be further operable to determine whether the data contains secure information. Responsive to determining that the data contains the secure information, the cognitive process may be further operable to generate an alert signal to alert an initiator of the action. The hardware processor further may be operable to determine whether the action is executed after alerting the initiator of the action. Responsive to determining that the action is executed, the hardware processor may be further operable to train the cognitive process to learn that the destination domain is permissible destination.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a cognitive process in one embodiment of the present disclosure.

FIG. 2 is a diagram illustrating components of a system in one embodiment of the present disclosure.

FIG. 3 illustrates a schematic of an example computer or processing system that may implement a cognitive confidentiality guardian system in one embodiment of the present disclosure.

### DETAILED DESCRIPTION

A system, method, and technique (also referred to as a guardian) may be presented. The guardian, for example, is a computer process capable of identifying confidential or secret materials, whether they are computer code (e.g., source code, object code), text, images or other information, and of detecting if the material is distributed inappropriately, for example, outside the organization or to a recipient who should not have that information within the organization. The guardian process may communicate with a local process to detect potential breaches of information security. In detecting possible breaches the guardian process continually improves its ability to detect breaches by incorporating feedback, for example, from the user or an administrator.

The guardian runs as a process on a user's system that (i) shares public network access, and (ii) is capable of accessing confidential or sensitive information. The guardian process is able to communicate with a server, which itself is accessible only from within the enterprise network and not the public internet. This server hosts a cognitive process capable of recognizing the confidential or sensitive information (e.g., of an organization) and of associating that information with permissible destinations for that information, and of training itself in both the detection of such information (e.g., incorporating user feedback) and in the permissible destinations for such information (e.g., incorporating addresses and domains explicitly marked as permissible, e.g., by users).

The confidential and/or sensitive information may be identified in several ways. A cognitive process in one embodiment of the present disclosure is capable of detecting sensitive diagrams or images, for example, and may utilize image processing technique. In the case of code, the cognitive process in one embodiment of the present disclosure may analyze variable names, patterns of keywords used and/or patterns of whitespace. Other idioms of the author may identify a piece of code as being likely to be of an authorship or belonging to a project. In the case of text, authorship may be inferred by vocabulary and patterns of punctuation, content analyzed by cognitive technique such as natural language classification, relationship extraction and/or another technique. Archives of compressed data may be categorized by name or checksum.

Training of the cognitive analysis process with material regarded as confidential and/or secret and the level of access control that should be maintained for each type of content establishes the ground truth for the training process. Ground truth is established by presenting material known to be confidential to the cognitive analysis process, i.e., material such as documents, images, chat logs and/or others, that discuss or contain confidential material. It is a basis for beginning the process of continual training and evaluation of subsequently examined material, e.g., by user feedback. The process establishes an example set of content that is regarded as confidential, and through continuous improvement by incorporating user decisions about what is and what is not actually confidential improves its ability to make these judgments. In some embodiments, feedback is continually incorporated through feedback, for example, from users and administrators.

In operation, a cognitive process of the present disclosure, in some embodiments, monitors and/or waits for any action, for example, user-initiated action, that may result in potentially sensitive information leaving the system being monitored. Where information is detected as being controlled and the destination is not marked as permissible, the cognitive process of the present disclosure in some embodiments sends a notification or alert signal, for example, warning the user of the potential breach of policy regarding the information. The cognitive process of the present disclosure may also show in the notification, a reason as to why the information is regarded as requiring protection and the type of breach that is about to take place.

For example, the cognitive process of the present disclosure in some embodiments may detect an action such as creating an email attachment or a paste operation from a system's clipboard. An unsafe operation with regard to confidential material may include any operation that may allow the material to cross the boundary from inside the organization to outside—an example is an email attachment which includes addresses that appear to be outside the organization. In some embodiments, the cognitive process of the present disclosure is capable of making an assessment at the point at which an attachment is made to a message having existing addresses, as well as an assessment at the point where destination addresses are added to a message that may already have an attachment of confidential material. Another example of an unsafe operation is pasting from a system clipboard to an external destination which may be a network drive, an unsecure chat channel, source code repository or any other destination that paste may apply. The cognitive process detects this action to be a potentially unsafe operation, and may request a user confirmation with a brief summary of why it the cognitive process determined the material to be confidential. The user may be then allowed to proceed with or abort the action. If a user proceeds with this action and confidence in detection of secret or confidential material is high, the system may send a next level of alert signal, for example, to an appropriate person such as a system administrator for review. In this example, the decision of the administrator may be used as the feedback to the cognitive process. In some embodiments, where confidence is not high, or the importance of the information is not sufficiently high to require oversight, for example, determined based on a defined threshold, the user's decision about the nature of the information may be the sole input into the feedback of the cognitive process. In other cases, both user decision and administrator feedback may be incorporated.

In some embodiments, the cognitive process of the present disclosure may function as a pre-emptive addressee filter as a user writes his email. This acts as a warning mechanism should a user intend to perform an action that would result in confidential data leaking. Responsive to detecting adding of an addressee that is not a known recipient of that class of information, the cognitive process sends an alert signal, warning the user on adding the addressee. If the user attempts to send the email, and if any such addressee still remains as a destination for the email, the cognitive process may send another alert signal.

For example, in existing email systems, a user-interface may automatically suggest an additional recipient based on an identity of an input recipient. For instance, if a user has typed in ‘userA@companyA.com’ and ‘userB@companyA.com’ in the ‘TO’ address field of the user's email, an email system may suggest ‘userC@companyB.com’ as an additional recipient. For example, the email system may recognize automatically that the user regularly communicates with this set of users and automatically suggests everyone in the group, if one or more in the group are typed-in.

The cognitive process in some embodiments of the present disclosure, in detecting that a user has entered one or more addressees (recipient addresses), may suggest removing an addressees from the list of recipients. For example, the cognitive process may determine that the content of the email or another communication addressed to the addresses contain confidential information or information that should not be sent to one or more of the addressees. The cognitive process, for example, may determine that the content contains confidential material by detecting keywords in the content. For example, referring to the above example, if the use has entered the addresses of ‘userA@companyA.com’, ‘userB @companyA.com’ and ‘userC@companyB.com’, the cognitive process may prompt to remove UserC from the recipient list, for example, based on cognitive analysis of the content of the email, where if company-confidential keywords are detected, the cognitive process determines that UserC is an external entity and thus should not be included. For instance, based on the UserC's email domain name, ‘companyB.com’, the cognitive process may recognize that UserC is external to the user sending the email, whereas the email domain names of userA and userB indicate ‘companyA.com’, which is internal to the user sending the email.

In some embodiments, lists may be built based on rules. For instance, if the cognitive process detects, for example, that an invention disclosure is being sent to an organizational address but also to a third party address (for example, to legal counsel) then the process may learn that this class of information may be sent to addresses with the domain names or the like of the third party in the future.

The cognitive process in some embodiments automatically identifies the classes of information that may be transmitted between domains of information during a computer data communications process in a computer network. Initially, the cognitive process may utilize information that is classified as sensitive or confidential. In some embodiment, the cognitive process may initially classify all information as sensitive, wherein as the initial classification is overridden, the cognitive process learns to unclassify the information. For example, a user may override a warning signal from the cognitive process and proceed with the transmission of the information over the computer network. As many such operations are completed with the transmission operation confirmed or aborted, the cognitive process is trained.

Domains represent a possible crossing of boundaries, where information may move from a controlled or safe domain to a public domain. Each domain may be classified as safe or unsafe for confidential or secret information. Examples of domains may include, but are not limited to, local storage on encrypted disk, email attachment to internal or public email addresses, system clipboard, a chat client window, a Universal Serial Bus (USB) drive, and a network store.

To protect information, in some embodiments of the present disclosure, an operating system-level process capable of communicating with a component of the cognitive process able to classify or to access classifications of information, monitors any information passing to a less safe domain. On detecting such an operation the system-level process may send a signal that warns the user of the potential consequences of this action. The user's decision about whether to proceed or abort is detected and used as a feedback to the cognitive process, improving classification of information. In this way mishandling and/or transmission of confidential information may be detected and prevented.

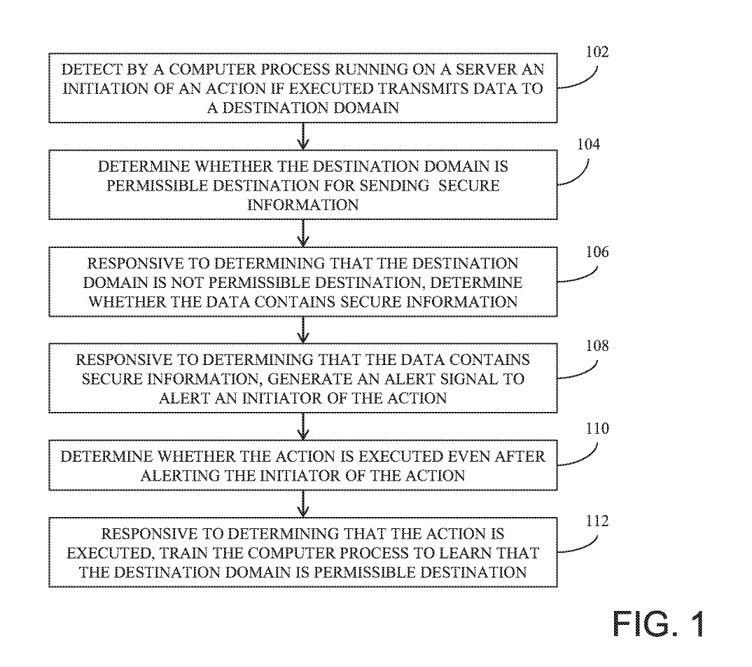

FIG. 1 is a flow diagram illustrating a cognitive process in one embodiment of the present disclosure. The method, for example, protects secure information in computer communications. The method is executed by at least one hardware processor. At 102, a computer process running on a server detects an initiation of an action, which action if executed transmits data to a destination domain. For instance, an operating system-level process may detect such an action. Examples of an action may include, but are not limited to, drafting of an electronic mail (e-mail), for example, typing or entering addresses in the ‘to’ field of an e-mail user interface; drafting an instant messaging application, for example, entering recipient's address or name in the ‘to’ field of the instant message application user interface; posting on a social network to a group of friends (contacts) via a social network web site accessed using a browser interface, and an online chat action.

At 104, it is determined as to whether the destination domain is a permissible destination for sending the secure information. Initially, a list of permissible destinations may be provided and compared with the destination domain. Still yet in some embodiments, the list of permissible destinations is an empty list initially. As the computer process learns which destinations are permissible, the list may be built.

At 106, responsive to determining that the destination domain is not a permissible destination, it is determined whether the data contains secure information. The data may include computer code and determining whether the data contains secure information may include analyzing the computer code for variable names, patterns of keywords used, patterns of white spaces, determining authorship of the computer code and a project identified with the computer code. In another aspect, the data may include text data and the determining whether the data contains secure information may include performing natural language processing to determine content of the text. Yet in another aspect, the data may include image data, and the determining whether the data contains secure information may include performing image processing.

As an example, for text and source code, whether the data contains secure information may be determined by performing a check for a series of characters, such as “- - - - -BEGIN RSA PRIVATE KEY- - - - -”, which may signal that the user may have accidentally included private encryption keys. The scanning computer may also look for long, unintelligible strings of characters in otherwise normal source code. Such strings may signal that working credentials (e.g., a unique identifier or API access key) may have been unintentionally included as part of the code. Processing of diagrams may include natural language programming (e.g., diagrams generally have labels) and image recognition processes. Additionally images or diagrams may contain metadata that identifies them as confidential, such as the name of the author, an identifying project, or an explicit confidentiality marker. If a user attempted to defeat the cognitive confidentiality guardian by removing the metadata, the metadata may be obfuscated or encoded. For example, a seemingly meaningless metadata field, such as the milliseconds part of a date field, may be changed to conform to a known sequence of numbers, to indicate or mark that the data contains confidential or secure information.

At 108, responsive to determining that the data contains secure information, an alert signal is generated to alert an initiator of the action. For example, a user initiating the action may be notified. In some embodiments, the computer process may determine that the data contains secure information with a confidence level, and based on the confidence level meeting a high alert threshold, the computer process may generate another or a second alert signal, for example, to notify another entity other than the user, for example, a system administrator. The computer process may also automatically recommend removing the destination domain from a list of destinations specified in the action.

At 110, it is determined as to whether the action is executed even after alerting the initiator of the action.

At 112, responsive to determining that the action is executed, the computer process is trained to learn that the destination domain is a permissible destination. The computer process may also be trained to learn that the data is not secure information. For example, features of a set of those destination domains known to be permissible destinations (or not permissible destinations) may be used as a training set to train a machine learning algorithm. Features of another set of destination domains known to be permissible destinations (or not permissible destinations) may be used as a test set to test and further train the machine learning algorithm. Based on feedback on machine predicted information (e.g., whether a destination is permissible or not), the machine learning algorithm may be retrained.

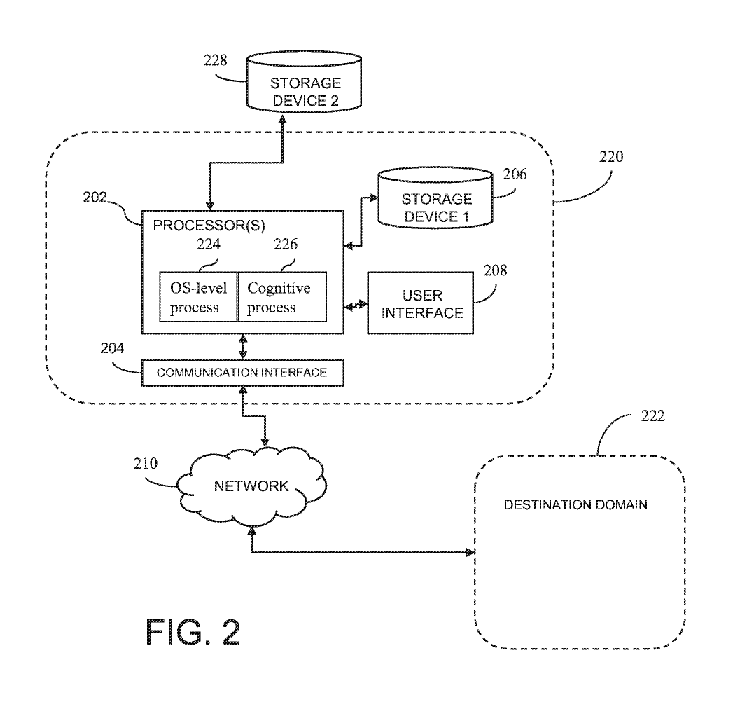

FIG. 2 is a diagram illustrating components of a system in one embodiment of the present disclosure. A hardware processor 202 may be coupled to a communication interface 204, for example, via which data may be transmitted. The hardware processor may run a computer operating system level process 224 that detects an initiation of an action, which action if executed transmits data to a destination domain 222 via the communication interface 204, for example, external to the domain 220 of the hardware processor. One or more storage devices 206, 208 may be coupled to the hardware processor(s) 202.

Similarly, a destination domain 222 may include one or more hardware processors, a user interface, a communication interface via which the one or more hardware processors may communicate to a network 210, and a storage device. The hardware processor 202 may run a cognitive process 226 that determines whether the destination domain 222 is a permissible destination for sending secure information. If the cognitive process determines that the destination domain is not a permissible destination for sending secure information, the cognitive process analyzes the data and determines whether the data contains secure information. If the cognitive process 226 determines that the data contains secure information, the cognitive process 226 may generate an alert signal to alert an initiator of the action, for example, via a user interface 208. The hardware processor 202 may also determine whether the action is executed after alerting the initiator of the action. Responsive to determining that the action is executed, the hardware processor 202 may train the cognitive process 206 to learn that the destination domain is a permissible destination. The cognitive process 206 may also be trained to learn that the content of the data is not secure information. A machine learning algorithm may be generated and trained as part of the cognitive process 206. In another aspect, a domain may be considered a storage device, in which example case, an external domain may be a storage device 228, external to a storage device 206 that may contain the data to be transmitted. The destination domain 222 may include any kind of device, storage mechanism or printer. An OS-level process 224 may include a kernel-level mechanism where processes capable of writing to file descriptors (e.g., in portable operating system interface for UNIX (POSIX), or other output resource) invoke the cognitive process 226 (e.g., confidentiality guardian functionality) for evaluation of destination domain security, and for example, also for content before a write operation may proceed.

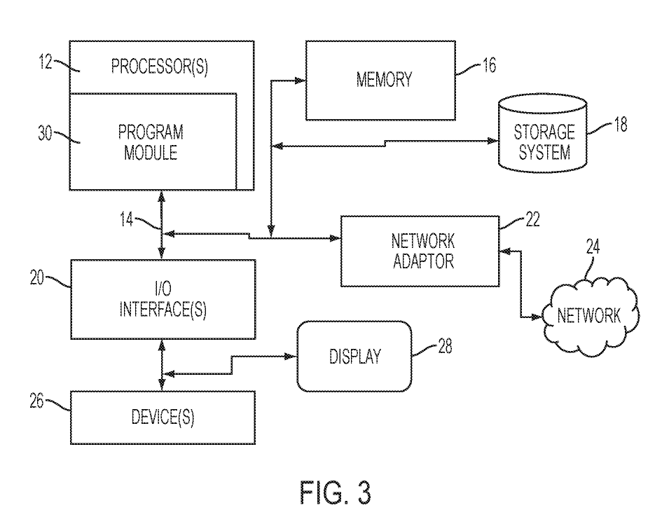

FIG. 3 illustrates a schematic of an example computer or processing system that may implement a cognitive confidentiality guardian system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of training a machine to protect secure information in computer communications, comprising:
detecting by a computer process running on a server an initiation of an action if executed transmits data to a destination domain;
determining whether the destination domain is a permissible destination for sending the secure information data contains secure information;
responsive to determining that the destination domain is not the permissible destination, determining whether the data contains secure information;
responsive to determining that the data contains secure information,
generating an alert signal to alert an initiator of the action;
determining whether the action is executed subsequent to alerting the initiator of the action; and
responsive to determining that the action is executed, training the computer process to learn that the destination domain is permissible destination.

2. The method of claim 1, further comprising, responsive to determining that the action is executed, training the computer process to learn that content of the data is not secure information.

3. The method of claim 1, wherein the data comprises computer code and determining whether the data contains secure information comprises analyzing the computer code for variable names, patterns of keywords used, patterns of white spaces, determining authorship of the computer code and a project identified with the computer code.

4. The method of claim 1, wherein the data comprises text and the determining whether the data contains secure information comprises performing natural language processing to determine content of the text.

5. The method of claim 1, wherein the data comprises image data, and the determining whether the data contains secure information comprises performing image processing.

6. The method of claim 1, wherein the computer process determines that the data contains secure information with a confidence level, and based on the confidence level meeting a high alert threshold, generating a second alert signal to a system administrator.

7. The method of claim 1, wherein the computer process automatically recommends removing the destination domain from a list of destinations in the action.

8. The method of claim 1, wherein the action comprises an action selected from the group consisting of an electronic mail action, an instant messaging action, posting on a social network, and an online chat action.

9. The method of claim 1, wherein the detecting by a computer process running on a server an initiation of an action if executed transmits data to a destination domain, comprises an operating system level process detecting of the initiation of the action.

10. A computer readable storage medium storing a program of instructions executable by a machine to perform a method of training a machine to protect secure information in computer communications, the method comprising:
detecting by a computer process running on a server an initiation of an action if executed transmits data to a destination domain;
determining whether the destination domain is a permissible destination for sending the secure information data contains secure information;
responsive to determining that the destination domain is not the permissible destination, determining whether the data contains secure information;
responsive to determining that the data contains secure information,
generating an alert signal to alert an initiator of the action;
determining whether the action is executed subsequent to alerting the initiator of the action; and
responsive to determining that the action is executed, training the computer process to learn that the destination domain is permissible destination.

11. The computer readable storage medium of claim 10, further comprising, responsive to determining that the action is executed, training the computer process to learn that content of the data is not secure information.

12. The computer readable storage medium of claim 10, wherein the data comprises computer code and determining whether the data contains secure information comprises analyzing the computer code for variable names, patterns of keywords used, patterns of white spaces, determining authorship of the computer code and a project identified with the computer code.

13. The computer readable storage medium of claim 10, wherein the data comprises text and the determining whether the data contains secure information comprises performing natural language processing to determine content of the text.

14. The computer readable storage medium of claim 10, wherein the data comprises image data, and the determining whether the data contains secure information comprises performing image processing.

15. The computer readable storage medium of claim 10, wherein the computer process determines that the data contains secure information with a confidence level, and based on the confidence level meeting a high alert threshold, generating a second alert signal to a system administrator.

16. The computer readable storage medium of claim 10, wherein the computer process automatically recommends removing the destination domain from a list of destinations in the action.

17. The computer readable storage medium of claim 10, wherein the action comprises an action selected from the group consisting of an electronic mail action, an instant messaging action, posting on a social network, and an online chat action.

18. The computer readable storage medium of claim 10, wherein the detecting by a computer process running on a server an initiation of an action if executed transmits data to a destination domain, comprises an operating system level process detecting of the initiation of the action.

19. A system of training a machine to protect secure information in computer communications, comprising:
at least one hardware processor coupled to a communication interface,
the hardware processor running a computer operating system level process operable to detect an initiation of an action if executed transmits data to a destination domain via the communication interface;
the hardware processor running a cognitive process operable to determine whether the destination domain is permissible destination for sending secure information;
responsive to determining that the destination domain is not the permissible destination, the cognitive process operable to determine whether the data contains secure information;
responsive to determining that the data contains the secure information, the cognitive process further operable to generate an alert signal to alert an initiator of the action;
the hardware processor further operable to determine whether the action is executed after alerting the initiator of the action;
responsive to determining that the action is executed, the hardware processor further operable to train the cognitive process to learn that the destination domain is permissible destination.

20. The system of claim 10, wherein responsive to determining that the action is executed, the hardware processor is further operable to train the computer process to learn that content of the data is not secure information.
